(19) United States
(12) Patent Application Publication
(10) Pub. No.: US 2026/0213165 A1
(43) Pub. Date: Jul. 23, 2026

(54) POSITIVE ELECTRODE ACTIVE MATERIAL LAYER, POSITIVE ELECTRODE, AND ALL-SOLID-STATE SECONDARY BATTERY

(71) Applicant: TDK CORPORATION, Tokyo (JP)

(72) Inventors: Yusuke KUME, Tokyo (JP); Akinobu NOJIMA, Tokyo (JP)

(73) Assignee: TDK CORPORATION, Tokyo (JP)

(21) Appl. No.: 19/141,959

(22) PCT Filed: Dec. 22, 2023
(86) PCT No.: PCT/JP2023/046248

§ 371 Date: Jun. 20, 2025

(30) Foreign Application Priority Data
Dec. 22, 2022 (JP) 2022-205482

(51) Int. Cl. H01M 4/36; H01M 4/02; H01M 4/525; H01M 10/0562

(52) U.S. Cl. CPC H01M 4/366; H01M 4/525; H01M 10/0562; H01M 2004/021; H01M 2004/028; H01M 2300/008

(57) ABSTRACT

A positive electrode active material layer contains a positive electrode active material and a solid electrolyte, where the positive electrode active material contains a particle having a core-shell structure that has a core part and a shell part covering at least a part of a surface of the core part, the core part consists of a lithium transition metal oxide, the shell part consists of a compound containing oxygen and at least one halogen element selected from the group consisting of F, Cl, Br, and I, and the solid electrolyte includes a halide-based solid electrolyte.

### TECHNICAL FIELD

The present invention relates to a positive electrode active material layer, a positive electrode, and an all-solid state secondary battery.

Priority is claimed on Japanese Patent Application No. 2022-205482, filed Dec. 22, 2022, the content of which is incorporated herein by reference.

### BACKGROUND ART

In recent years, the development of electronic technology has been remarkable, and portable electronic apparatuses are becoming smaller, lighter, thinner, and more multifunctional. In association with this, there is a strong demand for the improvement of a battery, which serves as a power source for an electronic apparatus, such that the battery is smaller, lighter, thinner, and more reliable. Accordingly, an all-solid state secondary battery, which uses a solid electrolyte as an electrolyte, has attracted attention. In the related art, as a solid electrolyte of an all-solid state secondary battery, an oxide-based solid electrolyte, a sulfide-based solid electrolyte, a complex hydride-based solid electrolyte, a halide-based solid electrolyte, and the like are known.

As a negative electrode active material for an all-solid state battery, a negative electrode active material including a core part that contains a carbon material and a shell part that coats at least a part of the surface of the core part is proposed (see Patent Document 1). In Patent Document 1, it is described that the shell part contains a metal oxide.

### CITATION LIST

### Patent Document

[Patent Document 1] Japanese Patent No. 7038951 (B)

### SUMMARY OF INVENTION

### Technical Problem

However, the all-solid state secondary battery in the related art has insufficient self-discharge characteristics, and thus the deterioration of capacity in an open circuit state has become a problem.

In particular, in the all-solid state secondary battery using a halide-based solid electrolyte as a solid electrolyte, a cell voltage drop in a case of being allowed to stand in an open circuit state is remarkable, and thus self-discharge characteristics are required to be improved.

The present invention has been made in consideration of the above problems, and an object of the present invention is to provide a positive electrode active material layer that is capable of forming a positive electrode of an all-solid state secondary battery in which self-discharge is suppressed, and a positive electrode and an all-solid state secondary battery which include the positive electrode active material layer.

### Solution to Problem

In order to solve the above problems, the following means is provided.

A positive electrode active material layer according to one aspect of the present invention contains a positive electrode active material; and
a solid electrolyte,
wherein the positive electrode active material contains a particle having a core-shell structure that has a core part and a shell part covering at least a part of a surface of the core part,
the core part consisting of a lithium transition metal oxide represented by Formula (1),
the shell part consisting of a compound containing oxygen and at least one halogen element selected from the group consisting of F, Cl, Br, and I, and
the solid electrolyte includes a halide-based solid electrolyte represented by Formula (2).

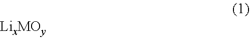

(In Formula (1), M is one or more kinds of transition metals. 0.1<x<1.1, 1.8<y<2.2)

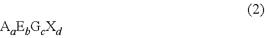

(In Formula (2), A is at least one element selected from Li and Cs. E is at least one element selected from the group consisting of Al, Sc, Y, Zr, Hf, and lanthanoids. G is at least group selected from the group consisting of OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, O, SO, SO₂, SO₃, SO₄, SO₅, S₂O₃, S₂O₄, S₂O₅, S₂O₆, S₂O₇, S₂O₈, BF₄, PF₆, and BOB. X is at least one element selected from the group consisting of F, Cl, Br, and I. 0.5≤a<6, 0<b<2, 0≤c≤6, 0<d≤6.1)

### Advantageous Effects of Invention

A positive electrode active material layer according to the present invention contains a positive electrode active material and a solid electrolyte, where the positive electrode active material contains a particle that has a core-shell structure including a core part consisting of a lithium transition metal oxide represented by Formula (1), and a shell part consisting of a compound containing oxygen and a halogen element and covering at least a part of a surface of the core part, and the solid electrolyte includes a halide-based solid electrolyte represented by Formula (2). As a result, a shell part consisting of a compound containing oxygen and a halogen element is disposed in a part of a space between the core part of the particle having the core-shell structure and the solid electrolyte. The halogen element is an element having high electronegativity. For this reason, the oxygen and the halogen element in the compound containing oxygen and a halogen element, which forms the shell part, form a strong covalent bond. As a result, the compound containing oxygen and a halogen element, which forms the shell part, is electrochemically stable. For this reason, in an all-solid state secondary battery having a positive electrode that includes the positive electrode active material layer according to the present invention, a reaction between the core part and the solid electrolyte is suppressed by the shell part. As a result, the all-solid state secondary battery is less likely to undergo a cell voltage drop due to a side reaction in a case of being allowed to stand in an open circuit state and thus has excellent self-discharge characteristics.

### BRIEF DESCRIPTION OF DRAWINGS

FIG. 1 is a schematic cross-sectional view showing an all-solid state secondary battery according to a first embodiment.

FIG. 2A is a schematic cross-sectional view showing a part of a positive electrode active material layer 1B of an all-solid state secondary battery 100 shown in FIG. 1.

FIG. 2B is an enlarged cross-sectional view showing a part of FIG. 2A.

### DESCRIPTION OF EMBODIMENTS

In order to solve the above problems, the inventors of the present invention focused on a reaction between a positive electrode active material and a solid electrolyte in a positive electrode active material layer containing a solid electrolyte containing a halogen element and repeated diligent studies.

As a result, it was found that it is sufficient to form an all-solid state secondary battery structure having a positive electrode active material layer that contains a positive electrode active material consisting of a specific lithium transition metal oxide and a solid electrolyte including a specific halide-based solid electrolyte, and to react the positive electrode active material and the solid electrolyte in the positive electrode active material layer by carrying out the initial charging and discharging at a high temperature of 60° C. to 85° C., thereby generating a compound containing oxygen and a halogen element along at least a part of the surface of the particle of the positive electrode active material.

The compound containing oxygen and a halogen element, which is generated along at least a part of the surface of the particle of the positive electrode active material, is presumed to be a compound that is generated by a reaction between oxygen released from the positive electrode active material and a halogen element diffused from the solid electrolyte by charging and discharging the all-solid state secondary battery at a high temperature of 60° C. to 85° C. The compound containing oxygen and a halogen element is electrochemically stable since it has a strong covalent bond between a halogen element having high electronegativity and oxygen. For this reason, the compound containing oxygen and a halogen element, which is generated along at least a part of the surface of the particle of the positive electrode active material, is less likely to be decomposed, the contact area between the positive electrode active material and the solid electrolyte is reduced, and a reaction between the positive electrode active material and the solid electrolyte is suppressed in a case of being allowed to stand in an open circuit state.

Based on the above finding, the inventors of the present invention further carried out studies. As a result, it was found that an all-solid state secondary battery structure having a positive electrode active material layer that contains a positive electrode active material consisting of a specific lithium transition metal oxide, a solid electrolyte including a specific halide-based solid electrolyte, and a compound containing a halogen element different from the halogen element contained in the solid electrolyte may be formed, and the positive electrode active material and a compound containing a halogen element in the positive electrode active material layer may be reacted by carrying out the initial charging and discharging at a high temperature of 60° C. to 85° C., thereby generating a compound containing oxygen and a halogen element along at least a part of the surface of the particle of the positive electrode active material.

In this way, the compound containing oxygen and a halogen element, which is generated along at least a part of the surface of the particle of the positive electrode active material, is also less likely to be decomposed since it is electrochemically stable, the contact area between the positive electrode active material and the solid electrolyte is reduced, and a reaction between the positive electrode active material and the solid electrolyte is suppressed in a case of being allowed to stand in an open circuit state.

For these reasons, in a positive electrode including a positive electrode active material layer that contains a positive electrode active material consisting of a specific lithium transition metal oxide and a solid electrolyte including a specific halide-based solid electrolyte, and in which at least a part of the surface of the particle of the positive electrode active material is coated with a compound containing oxygen and a halogen element, it is presumed that a cell voltage drop due to a side reaction is less likely to occur in a case where an all-solid state secondary battery having this positive electrode is allowed to stand in an open circuit state, and thus the self-discharge characteristics are excellent.

The present invention includes the following aspects.
[1] A positive electrode active material layer containing:
a positive electrode active material; and
a solid electrolyte,
wherein the positive electrode active material contains a particle having a core-shell structure that has a core part and a shell part covering at least a part of a surface of the core part,
the core part consists of a lithium transition metal oxide represented by Formula (1),
the shell part consists of a compound containing oxygen and at least one halogen element selected from the group consisting of F, Cl, Br, and I, and
the solid electrolyte includes a halide-based solid electrolyte represented by Formula (2).

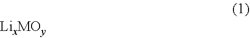

(In Formula (1), M is one or more kinds of transition metals. 0.1<x<1.1, 1.8<y<2.2)

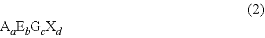

(In Formula (2), A is at least one element selected from Li and Cs. E is at least one element selected from the group consisting of Al, Sc, Y, Zr, Hf, and lanthanoids. G is at least group selected from the group consisting of OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, O, SO, SO₂, SO₃, SO₄, SO₅, S₂O₃, S₂O₄, S₂O₅, S₂O₆, S₂O₇, S₂O₈, BF₄, PF₆, and BOB. X is at least one element selected from the group consisting of F, Cl, Br, and I. 0.5≤a<6, 0<b<2, 0≤c≤6, 0<d≤6.1)
[2] The positive electrode active material layer according to [1], wherein an average thickness of the shell part is 0.1 μm to 1.0 μm.
[3] The positive electrode active material layer according to [1] or [2], wherein a proportion of an area of the shell part to a cross sectional area of the particles having the core-shell structure is 1% to 40%.
[4] The positive electrode active material layer according to any one of [1] to [3], wherein the halogen element contained in the shell part and a halogen element contained in the solid electrolyte are the same elements.
[5] The positive electrode active material layer according to any one of [1] to [4], wherein a ratio of a content of halogen elements at an interface between the shell part and the core part to a content of halogen elements at an interface between the shell part and the solid electrolyte is 0.6 or more and less than 1.0.
[6] A positive electrode containing the positive electrode active material layer according to any one of [1] to [5].
[7] An all-solid state secondary battery containing:
the positive electrode according to [6];
a negative electrode; and
a solid electrolyte layer.
[8] The all-solid state secondary battery according to [7],
wherein the solid electrolyte layer contains a halide-based solid electrolyte represented by Formula (2),

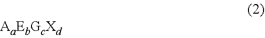

(in Formula (2), A is at least one element selected from Li and Cs,
E is at least one element selected from the group consisting of Al, Sc, Y, Zr, Hf, and lanthanoids,
G is at least group selected from the group consisting of OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, O, SO, SO₂, SO₃, SO₄, SO₅, S₂O₃, S₂O₄, S₂O₅, S₂O₆, S₂O₇, S₂O₈, BF₄, PF₆, and BOB, and
X is at least one element selected from the group consisting of F, Cl, Br, and I,
0.5≤a<6, 0<b<2, 0≤c≤6, 0<d≤6.1).
[9] The all-solid state secondary battery according to [8],
wherein the solid electrolyte layer contains Li₂ZrSO₄Cl₄.

Hereinafter, the positive electrode active material layer, the positive electrode, and the all-solid state secondary battery according to the present embodiment will be described in detail while referring to the drawings appropriately. The drawings that are used in the following description may show characteristics of the present invention on an enlarged scale for the sake of convenience in order to facilitate the understanding of the characteristics. As a result, the dimensional ratios or the like of the respective components may differ from the actual ones. The materials, dimensions, and the like, which are exemplified in the following description, are merely examples, and the present invention is not limited thereto. Therefore, an appropriate modification can be made within the scope that does not deviate from the gist of the present invention.

[all-Solid State Secondary Battery]

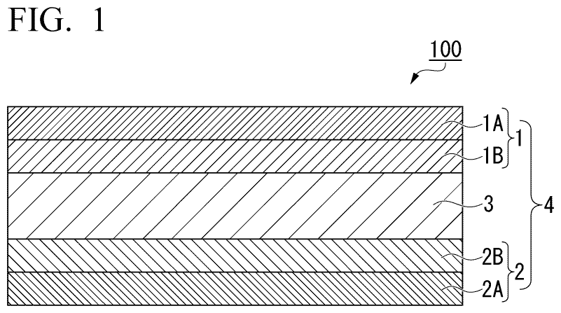

FIG. 1 is a schematic cross-sectional view showing an all-solid state secondary battery 100 according to the present embodiment. The all-solid state secondary battery 100 is used, for example, in a laminate battery, a square type battery, a cylinder type battery, a coin type battery, and a button type battery.

As shown in FIG. 1, the all-solid state secondary battery 100 has a laminate 4. A laminate 4 has a positive electrode layer 1 (positive electrode), a negative electrode layer 2 (negative electrode), and a solid electrolyte layer 3 sandwiched between the positive electrode layer 1 and the negative electrode layer 2. As shown in FIG. 1, the number of layers of each of the positive electrode layer 1 and the negative electrode layer 2 which are included in the laminate 4 may be one layer or may be two or more layers.

One end of the positive electrode layer 1 shown in FIG. 1 is connected to a first external terminal (not shown in the drawing). One end of the negative electrode layer 2 is connected to a second external terminal (not shown in the drawing). The first external terminal and the second external terminal are formed of a conductive material and are each electrically connected to the outside.

The all-solid state secondary battery 100 shown in FIG. 1 carries out charging or discharging by the exchange of ions between the positive electrode layer 1 and the negative electrode layer 2 with the solid electrolyte layer 3 being interposed between the positive electrode layer 1 and the negative electrode layer 2.

### “Positive Electrode Layer”

As shown in FIG. 1, the positive electrode layer 1 has a positive electrode current collector 1A and a positive electrode active material layer 1B. As shown in FIG. 1, the positive electrode active material layer 1B may be formed only on one surface of the positive electrode current collector 1A or may be formed on both surfaces of the positive electrode current collector 1A.

### (Positive Electrode Current Collector)

The positive electrode current collector 1A has an excellent conductance. A positive electrode current collector 1A consists of, for example, a metal such as silver, palladium, gold, platinum, aluminum, copper, nickel, stainless steel, or iron, and an alloy thereof. The positive electrode current collector 1A may include, for example, a positive electrode active material such as a lithium vanadium compound (LiV₂O₅, Li₃V₂(PO₄)₃, or LiVOPO₄).

### (Positive Electrode Active Material Layer)

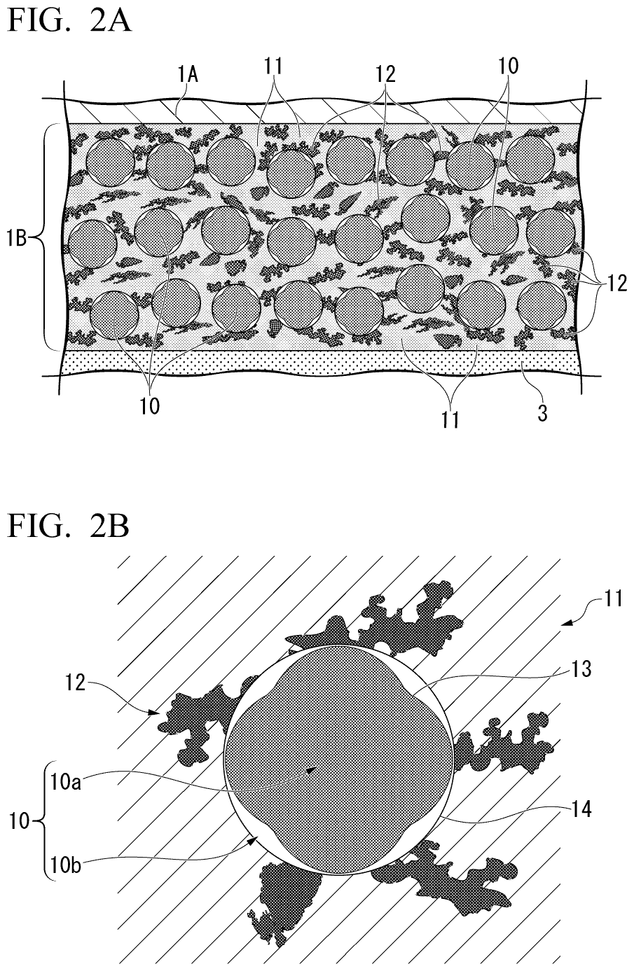

FIG. 2A is a schematic cross-sectional view showing a part of a positive electrode active material layer 1B of an all-solid state secondary battery 100 shown in FIG. 1. FIG. 2B is an enlarged schematic cross-sectional view showing a part of FIG. 2A. As shown in FIG. 2A and FIG. 2B, the positive electrode active material layer 1B includes a particle 10 having a core-shell structure, which is a positive electrode active material, and a solid electrolyte 11. As shown in FIG. 2A and FIG. 2B, the positive electrode active material layer 1B according to the present embodiment may include the conductive auxiliary agent 12.

### (Positive Electrode Active Material)

The positive electrode active material allows the reversible progression of the release and absorption of ions (for example, lithium ions), and the desorption and insertion of ions.

As shown in FIG. 2B, the positive electrode active material includes a plurality of particles 10 that has a core-shell structure including a particle-shaped core part 10a and the shell part 10b covering at least a part of the core part 10a. As shown in FIG. 2B, the shell part 10b may cover only a part of the surface of the core part 10a or may cover the entire surface of the core part 10a. In the shell part 10b, ions such as lithium ions can be diffused. As a result, even in a case where the particle 10 in which the entire surface of the core part 10a is coated with the shell part 10b is used as the positive electrode active material, the all-solid state secondary battery 100 having the positive electrode active material layer 1B containing the particle 10 can be charged and discharged.

As shown in FIG. 2A, the plurality of particles 10 included in the positive electrode active material may be only particles in which a part of the surface of the core part 10a is covered by the shell part 10b, may be only particles in which the entire surface of the core part 10a may be covered by the shell part 10b, or may be those in which both the particles described above are mixedly present at any proportion.

The particles 10 having a core-shell structure, which is included in the positive electrode active material, may be only one kind or may include two or more kinds of particles in which the materials that form the core part 10a and/or the shell part 10b are different from each other.

The core part 10a consists of a lithium transition metal oxide represented by Formula (1).

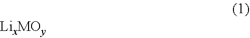

(In Formula (1), M is one or more kinds of transition metals. 0.1<x<1.1, 1.8<y<2.2)

In Formula (1), M is one or more kinds of transition metals. M preferably includes one or more kinds selected from Co, Ni, Mn, Fe, Mg, V, Ti, Al, Nb, Ti, Cu, and Cr, and more preferably includes one or more kinds selected from Co, Ni, Mn, and Al. This is because in a case where a method of carrying out the initial charging and discharging at a high temperature of 60° C. to 85° C. is used to react the core part 10a with a halogen element in a compound containing a halogen element (a halogen element contained in the solid electrolyte 11 and/or a halogen element contained in a compound containing a halogen element, where the halogen element is different from a halogen element contained in the solid electrolyte 11), where the compound is contained in the positive electrode active material layer, the shell part 10b having a sufficient thickness and having a sufficiently high proportion of an area of the cross sectional area of the particle 10 is easily formed.

x in Formula (1) satisfies at least 0.1<x<1.1 and still more preferably satisfies 0.2<x<0.6. This is because the lithium transition metal oxide represented by Formula (1) which forms the core part 10a has a stable crystal structure.

In Formula (1), y satisfies at least 1.8<y<2.2 and still more preferably satisfies 1.9<y<2.1. This is because the lithium transition metal oxide represented by Formula (1) which forms the core part 10a has a stable crystal structure.

Specific examples of the lithium transition metal oxide represented by Formula (1) include lithium cobaltate (LiCoO₂ (LCO)), lithium nickelate (LiNiO₂), a composite metal oxide represented by LiNiₓCo_{y}Mn_{z}MₐO₂ (x+y+z+a=1, 0≤x≤1, 0≤y≤1, 0≤z≤1, and 0≤a≤1 are satisfied, and M is one or more kinds of elements selected from Al, Mg, Nb, Ti, Cu, and Cr), and a composite metal oxides such as LiNiₓCo_{y}Al₂O₂ (0.9<x+y+z<1.1). Among these lithium transition metal oxides, any one selected from LiCoO₂ (LCO), LiNi_{1/3}Mn_{1/3}Co_{1/3}O₂ (NCM), and LiNi_{0.85}Co_{0.10}Al_{0.05}O₂ (NCA) is preferable, and LiCoO₂ (LCO) is most preferable. This is because in a case where the core part 10a is any one selected from LiCoO₂ (LCO), LiNi_{1/3}Mn_{1/3}Co_{1/3}O₂ (NCM), and LiNi_{0.85}Co_{0.10}Al_{0.05}O₂ (NCA), the particle 10 having a core-shell structure becomes such a particle that is capable of forming the all-solid state secondary battery 100 in which a side reaction in a case of being allowed to stand in an open circuit state is much less likely to occur, and still more excellent self-discharge characteristics are provided.

As shown in FIG. 2A and FIG. 2B, the core part 10a has a particle shape. The particle diameter of the core part 10a can be set to, for example, 5 μm to 30 μm, and it is preferably 10 μm to 25 μm. This is because in a case where the particle diameter of the core part 10a is within the above-described range, the shell part 10b having a sufficient thickness and having an appropriate proportion of an area of a cross sectional area of the particle 10 is easily formed in a case where a method of carrying out the initial charging and discharging at a high temperature of 60° C. to 85° C. is used to react the core part 10a with a halogen element in a compound containing a halogen element, where the compound is contained in the positive electrode active material layer.

The shell part 10b consists of a compound containing oxygen and at least one halogen element selected from the group consisting of F, Cl, Br, and I.

The halogen element contained in the shell part 10b is at least one selected from the group consisting of F, Cl, Br, and I, and it preferably includes Br and/or CI, that is, at least one of Br and Cl. This is because the shell part 10b becomes such a shell part that consists of a compound having an appropriate covalent bonding force with oxygen, and the particle 10 becomes such a particle that is capable of effectively suppressing a side reaction in a case of being allowed to stand in an open circuit state. In other words, in a case where the halogen element is selected as described above, the shell part 10b consists of a compound having a strong covalent bonding force with oxygen, and thus in the all-solid state secondary battery including the shell part 10b, it is possible to effectively suppress a side reaction in a case of being allowed to stand in an open circuit state.

The halogen element contained in the shell part 10b may be the same element as or different from the halogen element contained in the solid electrolyte of the positive electrode active material layer 1B. In a case where the particle 10 having a core-shell structure includes the particle 10 having a plurality of kinds of core-shell structures, particles in which the halogen element contained in the shell part 10b is the same element as the halogen element contained in the solid electrolyte of the positive electrode active material layer 1B, and particles in which the halogen element contained in the shell part 10b is different from the halogen element contained in the solid electrolyte of the positive electrode active material layer 1B may be mixedly present at any proportion. That is, particles consisting of the same halogen element as the halogen element contained in the positive electrode active material layer 1B and particles consisting of a halogen element different from the halogen element contained in the positive electrode active material layer 1B may be mixedly present at any proportion in the shell part 10b.

In the present embodiment, all of the particles 10 having a core-shell structure are preferably such that the halogen element contained in the shell part 10b is the same element as the halogen element contained in the solid electrolyte of the positive electrode active material layer 1B. This is because the positive electrode active material layer 1B is capable of forming the all-solid state secondary battery 100 in which a side reaction in a case of being allowed to stand in an open circuit state is much less likely to occur, and still more excellent self-discharge characteristics are provided. In addition, in a case where the halogen element contained in the shell part 10b is the same element as the halogen element contained in the solid electrolyte of the positive electrode active material layer 1B, it is possible to easily manufacture a positive electrode active material layer 1B that contains the positive electrode active material including the particle 10 having a core-shell structure including the core 10a and the shell part 10b and contains the solid electrolyte 11, by using a method of carrying out the initial charging and discharging at a high temperature of 60° C. to 85° C. without using a compound containing a halogen element different from the halogen element contained in the solid electrolyte 11.

The shell part 10b preferably consists of oxygen, at least one halogen element selected from the group consisting of F, Cl, Br, and I, Li, and M (one or more transition metals) in Formula (1) which forms the core part 10a. This is because it is possible to easily manufacture a positive electrode active material layer 1B that contains the positive electrode active material including the particle 10 having a core-shell structure including the core 10a and the shell part 10b and contains the solid electrolyte 11, by using a method of carrying out the initial charging and discharging at a high temperature of 60° C. to 85° C. without using a compound containing a halogen element different from the halogen element contained in the solid electrolyte 11.

The average thickness of the shell part 10b is preferably 0.1 μm to 1.0 μm, and more preferably 0.3 μm to 0.8 μm. In a case where the average thickness of the shell part 10b is 0.1 μm or more, the desorption of oxygen from the core part 10a can be effectively suppressed in the all-solid state secondary battery 100 having the positive electrode layer 1 that includes the positive electrode active material layer 1B. As a result, the reaction between the core part 10a and the solid electrolyte 11 can be more effectively suppressed. As a result, the all-solid state secondary battery 100 having the positive electrode layer 1 that includes the positive electrode active material layer 1B according to the present embodiment becomes an all-solid state secondary battery in which a side reaction in a case of being allowed to stand in an open circuit state is much less likely to occur, and still more excellent self-discharge characteristics are provided. In a case where the average thickness of the shell part 10b is 1.0 μm or less, it is possible to easily manufacture a positive electrode active material layer 1B that contains the positive electrode active material including the particle 10 having a core-shell structure including the core 10a and the shell part 10b and contains the solid electrolyte 11, by using a method of carrying out the initial charging and discharging at a high temperature of 60° C. to 85° C.

### (Average Thickness of Shell Part 10b)

The average thickness of the shell part 10b in the present embodiment is a value measured according to the method shown below.

A cut cross section of a positive electrode active material layer 1B is observed at a magnification of 30 k times using a scanning electron microscope (SEM) to obtain a gray scale image of 256 tones of the particles 10 having a core-shell structure. In the particle 10 having a core-shell structure in the obtained image, a light color region (whiteish region (average brightness of 193 to 207 in terms of gray scale)) is defined as the core part 10a, and a dark color region (blackish region (average brightness of 174 to 187 in terms of gray scale)) is defined as the shell part 10b. Regarding any one particle 10 having a core-shell structure in a field of view, the thickness of the shell part 10b along the diameter direction of the particles 10 is measured at any five locations, and the average value thereof is defined as the average thickness of the shell part 10b.

A proportion of the area of the shell part 10b to the cross sectional area of the particles 10 having a core-shell structure is preferably 1% to 40%, and more preferably 15% to 30%. In a case where the proportion of the area of the shell part 10b is 1% or more, the contact area between the core part 10a and the solid electrolyte 11 can be effectively reduced by the shell part 10b. As a result, the desorption of oxygen from the core part 10a of the all-solid state secondary battery 100 to the solid electrolyte 11 is suppressed, and the reaction between the core part 10a and the solid electrolyte 11 is suppressed more effectively. As a result, it is possible to form the all-solid state secondary battery 100 in which a side reaction in a case of being allowed to stand in an open circuit state is much less likely to occur, and still more excellent self-discharge characteristics are provided.

In a case where the proportion of the area of the shell part 10b to the cross sectional area of the particle 10 having a core-shell structure is 40% or less, the proportion of the area of the shell part 10b is too high, and thus the diffusion of ions such as lithium ions in the particle 10 is not hindered. In addition, in a case where the proportion of the area of the shell part 10b is 40% or less, it is possible to easily manufacture a positive electrode active material layer 1B that contains the positive electrode active material including the particle 10 having a core-shell structure including the core 10a and the shell part 10b and contains the solid electrolyte 11, by using a method of carrying out the initial charging and discharging at a high temperature of 60° C. to 85° C.

### (Proportion of Area of Shell Part 10b to Cross Sectional Area of Particle 10 Having Core-Shell Structure)

The proportion of the area of the shell part 10b to the cross sectional area of the particles 10 having a core-shell structure in the present embodiment is a value measured according to the method shown below.

A gray scale image of 256 tones of the particles 10 having a core-shell structure is obtained in the same manner as in the case where the average thickness of the shell part 10b is measured. Regarding the particle 10 having a core-shell structure in the obtained image, a light color region is defined as the core part 10a, and a dark color region is defined as the shell part 10b in the same manner as in the case where the average thickness of the shell part 10b is measured. In addition, regarding each of any five particles 10 having a core-shell structure in the field of view, an area of the core part 10a and an area of the shell part 10b are determined. Using the obtained value, the proportion of the area of the shell part 10b to the cross sectional area of each of the particles 10 having a core-shell structure ({area of shell part 10b/(area of core part 10a+ area of shell part 10b)}×100(%)) is calculated for the five particles 10 having a core-shell structure, and the average value thereof is defined as the proportion of the area of the shell part 10b to the cross sectional area of the particle 10 having a core-shell structure.

In the particle 10 having a core-shell structure shown in FIG. 2B, a ratio of a content of halogen elements at an interface 13 between the shell part 10b and the core part 10a to a content of halogen elements at an interface 14 between the shell part 10b and the solid electrolyte 11 (interface between shell part 10b and core part 10a/interface between shell part 10b and solid electrolyte 11) is preferably 0.6 or more and less than 1.0, and more preferably 0.6 to 0.9. As the portion in the shell part 10b is closer to the interface 14 between the shell part 10b and the solid electrolyte 11 in the shell part 10b, the content of the halogen element diffused from a compound containing a halogen element becomes larger, where the compound is contained in the positive electrode active material layer, in a case where the particle 10 having a core-shell structure is generated by using a method of carrying out the initial charging and discharging at a high temperature of 60° C. to 85° C. On the other hand, as the portion in the shell part 10b is closer to the interface 13 between the shell part 10b and the core part 10a in the shell part 10b, the content of the halogen element becomes smaller.

In a case where the ratio of the content of halogen elements at the interface 13 to the content of halogen elements at the interface 14 is 0.6 or more, a sufficient amount of halogen elements are contained in the entire shell part 10b. As a result, a strong covalent bond between the halogen element and oxygen is sufficiently formed in the shell part 10b. Accordingly, the shell part 10b that is electrochemically stable is provided in the positive electrode active material layer 1B. As a result, the particle 10 having a core-shell structure becomes such a particle that is capable of forming the all-solid state secondary battery 100 in which a side reaction in a case of being allowed to stand in an open circuit state is much less likely to occur, and still more excellent self-discharge characteristics are provided. In addition, in a case where the ratio at the interfaces described above is less than 1.0, it is possible to easily manufacture a positive electrode active material layer 1B that contains the positive electrode active material including the particle 10 having a core-shell structure including the core 10a and the shell part 10b and contains the solid electrolyte 11, by using a method of carrying out the initial charging and discharging at a high temperature of 60° C. to 85° C. In addition, in a case where the ratio at the interfaces described above is less than 1.0, the particle 10 becomes such a particle in which excess covalent bonds between the halogen element and oxygen is suppressed at the interface 13 between the shell part 10b and the core part 10a in the shell part 10b, and thus the core part 10a has a stable crystal structure. As a result, the particle 10 becomes such a particle that is capable of forming the all-solid state secondary battery 100 having still more excellent self-discharge characteristics.

### (Ratio of Content of Halogen Element)

The ratio of the content of halogen elements at the interface 13 between the shell part 10b and the core part 10a to the content of halogen elements at the interface 14 between the shell part 10b and the solid electrolyte 11 in the particle 10 having a core-shell structure in the present embodiment is a value measured according to the method shown below.

Any five particles 10 having a core-shell structure in a cut cross section of the positive electrode active material layer 1B are subjected to a mapping analysis of halogen elements in a measurement range of a square of 3 μm long and 3 μm wide (measurement interval: 0.1 μm) by using a scanning transmission electron microscope (STEM) energy dispersive X-ray spectroscopy (EDS) device. Then, regarding each of any five particles 10 having a core-shell structure in the field of view, the ratio of the content of the halogen elements (interface 13 between shell part 10b and core part 10a/interface 14 between shell part 10b and solid electrolyte 11) is calculated using a measured value at a location closest to the interface with the core part 10a and a measured value at a location closest to the interface with the solid electrolyte 11 in the shell part 10b having the greatest thickness along the diameter direction of the particle 10, and the average value thereof is calculated.

The positive electrode active material contained in the positive electrode active material layer 1B according to the present embodiment may be only the particle 10 having a core-shell structure as shown in FIG. 2A, or a positive electrode active material that is used in a publicly known all-solid state secondary battery may be contained together with the particle 10 having a core-shell structure, in a range where the effect of the present application can be obtained. Examples of the positive electrode active material which may be contained together with particle 10 having a core-shell structure include a particle consisting of a core part 10a that is not coated with the shell part 10b.

### (Solid Electrolyte)

The solid electrolyte 11 contained in the positive electrode active material layer 1B improves ion conductivity in the positive electrode active material layer 1B.

The solid electrolyte 11 contained in the positive electrode active material layer 1B includes a halide-based solid electrolyte represented by Formula (2).

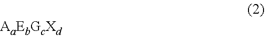

(In Formula (2), A is at least one element selected from Li and Cs. E is at least one element selected from the group consisting of Al, Sc, Y, Zr, Hf, and lanthanoids. G is at least group selected from the group consisting of OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, O, SO, SO₂, SO₃, SO₄, SO₅, S₂O₃, S₂O₄, S₂O₅, S₂O₆, S₂O₇, S₂O₈, BF₄, PF₆, and BOB. X is at least one element selected from the group consisting of F, Cl, Br, and I. 0.5≤a<6, 0<b<2, 0≤c≤6, 0<d≤6.1)

A in Formula (2), A is an essential component and is at least one element selected from Li and Cs, and it is preferably Li, or both Li and Cs, and more preferably Li.

In Formula (2), a satisfies 0.5≤a<6, preferably satisfies 2.0≤a≤4.0 and more preferably satisfies 2.5≤a≤3.5. In a case where a is 0.5≤a<6, the content of A contained in the halide-based solid electrolyte represented by Formula (2) becomes appropriate, and the ion conductivity of the solid electrolyte 11 becomes sufficiently high.

E in Formula (2) is an essential component that improves the ion conductivity of the solid electrolyte 11. In Formula (2), E is at least one element selected from the group consisting of Al, Sc, Y, Zr, Hf, and lanthanoids (La, Ce, Pr, Nd, Pm, Sm, Eu, Gd, Tb, Dy, Ho, Er, Tm, Yb, and Lu). E is preferably at least one element selected from the group consisting of Al, Sc, Y, Zr, Hf, and La, more preferably includes Al and/or Zr, and is most preferably Zr.

In Formula (2), b is 0<b<2. b is preferably 0.6≤b≤1, since the effect of improving the ion conductivity of the solid electrolyte 11 by containing E is more remarkable.

In Formula (2), G is at least group selected from the group consisting of OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, O, SO, SO₂, SO₃, SO₄, SO₅, S₂O₃, S₂O₄, S₂O₅, S₂O₆, S₂O₇, S₂O₈, BF₄, PF₆, and BOB. G is preferably at least one group selected from the group consisting of O, SO, SO₂, SO₃, and SO₄, and in particular, it is preferably O and/or SO₄.

In Formula (2), c satisfies 0≤c≤6. In a case where the halide-based solid electrolyte represented by Formula (2) contains G (0<c), the potential window on the reduction side of the solid electrolyte 11 becomes wider, which makes reduction difficult. c is preferable to satisfy 0.5≤c, since the effect of widening the potential window on the reduction side by containing G becomes more remarkable. c is preferable to satisfy c≤3 in order to prevent a decrease in the ion conductivity of the solid electrolyte due to an excessively large content of G.

In Formula (2), X is an essential component that improves the ion conductivity of the solid electrolyte 11. In Formula (2), X is at least one selected from the group consisting of F, Cl, Br, and I, and the effect obtained in a case where the positive electrode active material layer 1B contains the particle 10 having a core-shell structure is remarkable. Therefore, it is preferable to contain Br and/or Cl.

In Formula (2), d satisfies 0<d≤6.1. It is preferable that d satisfies 1≤d. In a case where d satisfies 1≤d, the ion conductivity of the solid electrolyte 11 becomes higher. In addition, d preferably satisfies d≤5 so that the potential window of the solid electrolyte 11 is not narrowed by having a too much higher content of X.

Specific examples of the halide-based solid electrolyte represented by Formula (2) include Li₂ZrSO₄Cl₄ (LZSOC), Li₂ZrCCl₄ (LZOC), Li₂ZrCl₆ (LZC), Li₂ZrBr₆ (LZBr), Li₂ZrBO₂Cl₅, Li₂ZrBF₄Cl₅, Li₃YSO₄Cl₄, Li₃YCO₃Cl₄, Li₃YBO₂Cl₅, and Li₃YBF₄Cl₅. Among these halide-based solid electrolytes, any one selected from Li₂ZrSO₄Cl₄ (LZSOC), Li₂ZrCCl₄ (LZOC), Li₂ZrCl₆ (LZC) is preferable, and Li₂ZrBr₆ (LZBr) or Li₂ZrSO₄Cl₄ (LZSOC) is more preferable. In a case where the halide-based solid electrolyte is any one selected from Li₂ZrSO₄Cl₄ (LZSOC), Li₂ZrCCl₄ (LZOC), Li₂ZrCl₆ (LZC), and Li₂ZrBr₆ (LZBr) the positive electrode active material layer 1B becomes such a positive electrode active material layer that is capable of forming the all-solid state secondary battery 100 in which a side reaction in a case of being allowed to stand in an open circuit state is much less likely to occur, and still more excellent self-discharge characteristics are provided.

The solid electrolyte 11 contained in the positive electrode active material layer 1B according to the present embodiment may be only one kind, or two or more kinds of solid electrolytes having compositions different from each other may be contained. In a case where the solid electrolyte 11 contains two or more kinds of solid electrolytes having compositions different from each other, all of the solid electrolytes may be a halide-based solid electrolyte represented by Formula (2), or a solid electrolyte that is used in a publicly known all-solid state secondary battery may be contained together with the halide-based solid electrolyte represented by Formula (2) in a range where the effect of the present application can be obtained. The solid electrolyte 11 contained in the positive electrode active material layer 1B according to the present embodiment may be the same as the solid electrolyte contained in the solid electrolyte layer 3 which will be described later.

### (Conductive Auxiliary Agent)

A conductive auxiliary agent 12 is not particularly limited as long as it improves the electron conductivity in the positive electrode active material layer 1B, and any publicly known conductive auxiliary agent can be used. The conductive auxiliary agent 12 may be in the form of each of powder and fiber. Examples of the conductive auxiliary agent 12 include a carbon-based material such as graphite, carbon black, graphene, or a carbon nanotube, a metal such as gold, platinum, silver, palladium, aluminum, copper, nickel, stainless steel, or iron, a conductive oxide such as indium tin oxide (ITO), and a mixture thereof. Among them, the conductive auxiliary agent 12 is preferably a carbon-based material such as a carbon nanotube since the physical strength of the positive electrode active material layer 1B can be improved.

In a case where the positive electrode active material layer 1B contains a sufficient amount of the conductive auxiliary agent 12, the electron conductivity in the positive electrode active material layer 1B is improved. In addition, in a case where the particle 10 having a core-shell structure is generated, at least a part of a surface of a particle-shaped material consisting of a lithium transition metal oxide represented by Formula (1) is coated with the conductive auxiliary agent 12 by carrying out the initial charging and discharging at a high temperature of 60° C. to 85° C., which hinders the diffusion of halogen elements from the solid electrolyte 11 into lithium transition metal oxide represented by Formula (1). As a result, the generation of the excess shell part 10b is suppressed, and the proportion of the area of the shell part 10b to the cross sectional area of the particle 10 having a core-shell structure becomes appropriate.

In the present embodiment, in a case where the particle 10 having a core-shell structure is sufficiently contained in the positive electrode active material layer 1B, the release and absorption of ions (for example, lithium ions), and the desorption and insertion of ions can be sufficiently carried out.

In addition, in a case where the solid electrolyte 11 consisting of the halide-based solid electrolyte represented by Formula (2) is sufficiently contained in the positive electrode active material layer 1B, the ion conductivity in the positive electrode active material layer 1B is improved. In addition, by carrying out the initial charging and discharging at a high temperature of 60° C. to 85° C., the amount of halogen elements diffused from the solid electrolyte 11 becomes sufficiently large in a case where the particles 10 having a core-shell structure are generated, and the shell part 10b is sufficiently generated.

The positive electrode active material layer 1B according to the present embodiment may contain the particle 10 having a core-shell structure, the solid electrolyte 11, and in addition to the conductive auxiliary agent 12 which may be contained as necessary, a compound containing the same halogen element as the halogen element contained in the shell part 10b of the particle 10 having a core-shell structure. Examples of the compound containing a halogen element include sodium chloride and sodium bromide.

### “Negative Electrode Layer”

As shown in FIG. 1, the negative electrode layer 2 has a negative electrode current collector 2A and a negative electrode active material layer 2B. As shown in FIG. 1, the negative electrode active material layer 2B may be formed only on one surface of the negative electrode current collector 2A or may be formed on both surfaces of the negative electrode current collector 2A.

### (Negative Electrode Current Collector)

The negative electrode current collector 2A is similar to the positive electrode current collector 1A.

### (Negative Electrode Active Material Layer)

The negative electrode active material layer 2B contains a negative electrode active material. The negative electrode active material layer 2B may contain a conductive auxiliary agent and a solid electrolyte.

### (Negative Electrode Active Material)

The negative electrode active material is a compound capable of absorbing and releasing ions. The negative electrode active material is a compound that exhibits a lower potential than the positive electrode active material. As the negative electrode active material, a publicly known material can be used, and a material similar to the material in the positive electrode active material can be used. The negative electrode active material and the positive electrode active material, which are used in the all-solid state secondary battery 100, are determined in consideration of the potential of the negative electrode active material and the potential of the positive electrode active material.

### (Conductive Auxiliary Agent)

The conductive auxiliary agent improves the electron conductivity of the negative electrode active material layer 2B. As the conductive auxiliary agent, a material similar to the material usable for the positive electrode active material layer 1B can be used.

### (Solid Electrolyte)

A solid electrolyte contained in the negative electrode active material layer 2B improves ion conductivity in the negative electrode active material layer 2B. As the solid electrolyte, one or more publicly known electrolytes can be mixed and used. Examples of the solid electrolyte include an oxide-based solid electrolyte, a sulfide-based solid electrolyte, a complex hydride-based solid electrolyte, and a halide-based solid electrolyte. The same solid electrolyte as the solid electrolyte 11 used for the positive electrode active material layer 1B described above may be used as the solid electrolyte.

### “Solid Electrolyte Layer”

The solid electrolyte layer 3 can move ions by an externally applied electric field. As the solid electrolyte that forms the solid electrolyte layer 3, one or more publicly known electrolytes can be mixed and used. Examples of the solid electrolyte include an oxide-based solid electrolyte, a sulfide-based solid electrolyte, a complex hydride-based solid electrolyte, and a halide-based solid electrolyte. Similar to the solid electrolyte 11 contained in the positive electrode active material layer 1B, the solid electrolyte layer 3 preferably contains a halide-based solid electrolyte represented by Formula (2) and preferably contains Li₂ZrSO₄Cl₄. This is because in a case where the solid electrolyte layer 3 contains Li₂ZrSO₄Cl₄, a reaction between the solid electrolyte layer 3 and a layer that serves as the positive electrode active material layer 1B proceeds easily at the interface between the solid electrode layer 3 and a layer that serves as the positive electrode active material layer 1B by carrying out the initial charging and discharging at a high temperature of 60° C. to 85° C.

### (Exterior Body)

In the all-solid state secondary battery 100 according to the present embodiment, it is preferable that the laminate 4 having the positive electrode layer 1, the solid electrolyte layer 3, and the negative electrode layer 2 is stored in an exterior body (not shown in the drawing) and sealed. The exterior body may be any exterior body as long as it can suppress the infiltration of moisture or the like from the outside into the inside. A publicly known exterior body can be used, and there is no particular limitation.

For example, an exterior body obtained by forming a metal laminate film obtained by coating both surfaces of a metal foil with a polymer film, in a sac shape, can be used as the exterior body. Such an exterior body is sealed by subjecting an opening portion to heat sealing.

As the metal foil that forms the metal laminate film, for example, an aluminum foil, a stainless steel foil, or the like can be used. As a polymer film that is disposed on the outer side of the exterior body, a polymer having a high melting point is preferably used, and for example, polyethylene terephthalate (PET), polyamide, or the like can be used. As a polymer film that is disposed on the inner side of the exterior body, for example, polyethylene (PE), polypropylene (PP), or the like can be used.

[Manufacturing Method for all-Solid State Secondary Battery]

Next, a manufacturing method for the all-solid state secondary battery 100 according to the present embodiment will be described.

In the present embodiment, a description will be made using, as an example, a case where the particle 10 including the shell part 10b that contains the same halogen element as the halogen element contained in the solid electrolyte 11 of the positive electrode active material layer 1B is generated as the particle 10 having a core-shell structure.

The all-solid state secondary battery 100 according to the present embodiment can be manufactured, for example, by using a powder molding method.

First, a resin holder having a through hole in the center, a lower punch, and an upper punch are prepared. In addition, each of a powdery positive electrode mixed agent that is a material of the positive electrode active material layer 1B, a powdery negative electrode mixed agent that is a material of the negative electrode active material layer 2B, and a powdery solid electrolyte that is a material of the solid electrolyte layer 3 is prepared.

In the present embodiment, a mixed powder of a powder (particle) consisting of a lithium transition metal oxide represented by Formula (1), a powder of a solid electrolyte including a halide-based solid electrolyte represented by Formula (2), and a powder of a conductive auxiliary agent contained as necessary is prepared as the positive electrode mixed agent. A composition of the powder (particle) consisting of the lithium transition metal oxide represented by Formula (1) corresponds to the composition of the core part 10a. A composition of the powder of the solid electrolyte including the halide-based solid electrolyte represented by Formula (2) corresponds to the composition of the solid electrolyte 11.

Then, the lower punch is inserted from under the through hole of the resin holder, and the positive electrode mixed agent, the solid electrolyte, and the negative electrode mixed agent, which are powdery materials, are charged in this order from the opening side of the resin holder. Next, the upper punch is inserted onto the charged powdery material, placed on a pressing machine and then pressed. The pressure of the pressing is, for example, 20 kPa.

The powdery material charged into the resin holder is pressed in the resin holder by the upper punch and the lower punch. As a result, a molded body, in which the positive electrode active material layer 1B, the solid electrolyte layer 3, and the negative electrode active material layer 2B are laminated, is obtained.

Next, according to a publicly known method, the positive electrode current collector 1A is installed on the positive electrode active material layer 1B of the molded body, and the negative electrode current collector 2A is installed under the negative electrode active material layer 2B. Through the above-described procedure, the laminate 4 in which the lamination has been carried out in the order of the positive electrode current collectors 1A/the positive electrode active material layer 1B/the solid electrolyte layer 3/the negative electrode active material layer 2B/the negative electrode current collectors 2A is obtained.

Next, according to a publicly known method, an external terminal is welded to each of the positive electrode current collector 1A of the positive electrode layer 1 and the negative electrode current collector 2A of the negative electrode layer 2, which form the laminate 4, and the positive electrode current collector 1A or the negative electrode current collector 2A is electrically connected to the external terminal. After that, the laminate 4 connected to the external terminal is stored in the exterior body. Then, the opening portion of the exterior body is sealed by heat sealing to form an all-solid state secondary battery structure.

In the present embodiment, the all-solid state secondary battery structure formed in this way is subjected to the initial charging and discharging at a high temperature of 60° C. to 85° C. In a case where the temperature in the initial charging and discharging is 60° C. or higher, oxygen separated from the lithium transition metal oxide reacts with a halogen element diffused from the halide-based solid electrolyte at the interface between the powder (particle) consisting of the lithium transition metal oxide represented by Formula (1) and the powder of the solid electrolyte including the halide-based solid electrolyte represented by Formula (2). As a result, the particle 10 having a core-shell structure including the core part 10a and the shell part 10b is generated.

In a case where the temperature in the initial charging and discharging is less than 60° C., the particle 10 having a core-shell structure is not generated. The temperature in the initial charging and discharging is 60° C. or more and preferably 70° C. or more, and it can be appropriately determined according to the time required for charging and discharging, and the like. In addition, in a case where the temperature in the initial charging and discharging is 85° C. or lower, oxygen separated from the lithium transition metal oxide does not excessively react with a halogen element diffused from the halide-based solid electrolyte, and thus the particle 10 having a stable crystal structure of the core part 10a is obtained.

It is preferable that the temperature difference between the temperature at the time of charging and the temperature at the time of discharging in the initial charging and discharging is 25° C. or lower.

It is noted that, in the related art, the charging and discharging of the all-solid state secondary battery structure are carried out at ordinary temperature (in a range of 20° C. to 30° C.). As a result, in the manufacturing method in the related art, an operation of heating the all-solid state secondary battery structure was carried out. In addition, it is not necessary to heat the all-solid state secondary battery structure in order to carry out the initial charging and discharging. Therefore, a device for heating the all-solid state secondary battery structure, such as a constant temperature bath, was unnecessary. It is noted that, in the related art, the charging and discharging of the all-solid state secondary battery structure may generate heat in the all-solid state secondary battery structure. However, even in a case where the all-solid state secondary battery structure generated heat, the entire all-solid state secondary battery structure did not reach a temperature exceeding 60° C. at the time of the initial charging and discharging.

Conditions other than temperature such as current and voltage in the initial charging and discharging for the all-solid state secondary battery structure can be set to the publicly known conditions and can be appropriately determined according to the use application of the all-solid state secondary battery 100 to be manufactured within a range where the particle 10 having a core-shell structure is generated.

As the initial charging and discharging for the all-solid state secondary battery structure, specifically, the method shown below can be used.

An all-solid state secondary battery structure is allowed to stand in a constant temperature bath at 60° C. to 85° C., and charging at a constant current is carried out at 0.01 C to 2.00 C until the battery voltage reaches 2.75 V to 2.85 V. Then, charging at a constant voltage is carried out for 0.5 to 8.0 hours at the reached battery voltage. After that, discharging at a constant current is carried out at 0.05 C until the battery voltage reaches 1.3 V.

In a case where the conditions for charging at a constant current in the initial charging are changed, the proportion of the area of the shell part 10b to the cross sectional area of the particle 10 having a core-shell structure is changed. Specifically, in a case where the condition for charging at a constant current in the initial charging is 0.02 C or more, the particles 10 in which the area proportion of the shell part 10b is 40% or less are easily generated, and in a case where the condition thereof is 0.04 C or more, the particles 10 in which the area proportion of the shell part 10b is 30% or less are easily generated. In a case where the condition for charging at a constant current in the initial charging is 2.00 C or less, the particles 10 in which the area proportion of the shell part 10b is 1% or more are easily generated, and in a case where the condition thereof is 0.50 C or less, the particles 10 in which the area proportion of the shell part 10b is 15% or more are easily generated.

In addition, in a case where the battery voltage at the upper limit in the initial charging is increased, the ratio of the content of halogen elements at the interface 13 between the shell part 10b and the core part 10a to the content of halogen elements at the interface 14 between the shell part 10b and the solid electrolyte 11 in the particle 10 having a core-shell structure tends to be decreased. In a case where the battery voltage at the upper limit in the initial charging is set to be low, the above-described ratio between the contents of halogen elements tends to be increased. In a case where the battery voltage at the upper limit in the initial charging is within a range of 2.75 V to 2.84 V, the particle 10 in which the above-described ratio between the contents of halogen elements is 0.6 or more and less than 1.0 is easily generated, and in a case where the battery voltage at the upper limit is 2.80 V to 2.84 V, the particle 10 in which the above-described ratio between the contents of halogen elements is 0.6 or more 0.9 or less is easily generated.

In a case where the time for charging at a constant voltage in the initial charging is lengthened, the average thickness of the shell part 10b becomes thicker, and in a case where the time for charging at a constant voltage is shortened, the average thickness of the shell part 10b becomes thinner. In a case where the time for charging at a constant voltage in the initial charging is 1.0 hours or more, the particle 10 in which the average thickness of the shell part 10b is 0.1 μm or more is easily generated, and in a case where the time for charging at a constant voltage is 3.0 hours or more, the particle 10 in which the average thickness of the shell part 10b is 0.3 μm or more is easily generated. In a case where the time for charging at a constant voltage in the initial charging is 7.0 hours or less, the particle 10 in which the average thickness of the shell part 10b is 1.0 μm or less is easily generated, and in a case where the time for charging at a constant voltage is 6.0 hours or less, the particle 10 in which the average thickness of the shell part 10b is 0.8 μm or less is easily generated.

In a case where the all-solid state secondary battery structure is subjected to the initial charging and discharging at a high temperature as described above, a lithium transition metal oxide represented by Formula (1) reacts with a halide-based solid electrolyte represented by Formula (2) in a layer that serves as the positive electrode active material layer 1B. Then, a compound containing oxygen and a halogen element is generated along at least a part of the surface of the particle consisting of the lithium transition metal oxide represented by Formula (1), and the particle 10 having a core-shell structure including the core part 10a and the shell part 10b is generated.

Through the above processes, the all-solid state secondary battery 100 can be manufactured.

Next, a description will be made using, as an example, a case where the particle 10 including the shell part 10b that contains a halogen element different from the halogen element contained in the solid electrolyte 11 of the positive electrode active material layer 1B is generated as the particle 10 having a core-shell structure.

In this case, the all-solid state secondary battery 100 can be manufactured in the same manner as the above-described manufacturing method, except that a mixed powder of a powder (particle) consisting of a lithium transition metal oxide represented by Formula (1), a powder of a solid electrolyte including a halide-based solid electrolyte represented by Formula (2), a powder of a compound containing a halogen element that is to be contained in the shell part 10b, and a powder of a conductive auxiliary agent contained as necessary is used as the positive electrode mixed agent.

The positive electrode mixed agent described above is preferably produced by a method in which a mixture is prepared by mixing a powder (particle) consisting of a lithium transition metal oxide represented by Formula (1), and a compound containing a halogen element that is to be contained in the shell part 10b, and the obtained mixture is mixed with a powder of a solid electrolyte including a halide-based solid electrolyte represented by Formula (2), and a powder of a conductive auxiliary agent contained as necessary. This is because in the positive electrode mixed agent produced by such a method described above, the contact area between the powder (particle) consisting of a lithium transition metal oxide and the compound containing a halogen element that is to be contained in the shell part 10b is sufficiently large as compared with the contact area between the above-described powder (particle) consisting of a lithium transition metal oxide and the above-described solid electrolyte. As a result, in a case where an all-solid state secondary battery structure manufactured using this positive electrode mixed agent is subjected to the initial charging and discharging at a high temperature as described above, the reaction between the powder (particle) consisting of a lithium transition metal oxide and the compound containing a halogen element takes precedence over a reaction between the above-described powder (particle) consisting of a lithium transition metal oxide and the above-described solid electrolyte.

A compound containing the same halogen element as the halogen element contained in the shell part 10b can be used as a compound containing a halogen element that is to be contained in the shell part 10b, where the compound is contained in the positive electrode mixed agent.

In a case where an all-solid state secondary battery structure manufactured using the above-described positive electrode mixed agent is subjected to the initial charging and discharging at a high temperature as described above, the lithium transition metal oxide represented by Formula (1) preferentially reacts with the compound containing a halogen element that is to be contained in the shell portion 10b, in a layer that serves as the positive electrode active material layer 1B. Then, a compound containing oxygen and a halogen element is generated along at least a part of the surface of the particle consisting of the lithium transition metal oxide represented by Formula (1), and the particle 10 having a core-shell structure including the core part 10a and the shell part 10b is generated.

Through the above processes, the all-solid state secondary battery 100 can be manufactured.

The positive electrode active material layer 1B according to the present embodiment contains a positive electrode active material and the solid electrolyte 11, where the positive electrode active material contains the particle 10 having a core-shell structure including the core part 10a that consists of a lithium transition metal oxide represented by Formula (1) and the shell part 10b that consists of a compound containing oxygen and at least one halogen element selected from the group consisting of F, Cl, Br, and I, and covers at least a part of the surface of the core part 10a, and the solid electrolyte 11 includes a halide-based solid electrolyte represented by Formula (2). As a result, the shell part 10b is disposed in a part of a space between the core part 10a of the particle 10 having a core-shell structure and the solid electrolyte 11. The compound containing oxygen and a halogen element, which forms the shell part 10b, is electrochemically stable. From the facts described above, in the all-solid state secondary battery 100 having the positive electrode layer 1 that includes the positive electrode active material layer 1B according to the present embodiment, a reaction between the core part 10a and the solid electrolyte 11 is suppressed by the shell part 10b, a side reaction in a case of being allowed to stand in an open circuit state is less likely to occur, and excellent self-discharge characteristics are provided.

As described above, the embodiments according to the present invention have been described in detail with reference to the drawings. However, each of the configurations and the combination thereof in each embodiment are examples, and additions, omissions, substitutions, and other modifications of the configuration can be made without departing from the spirit of the present invention.

### EXAMPLES

### Example 1

### (Production of Positive Electrode Mixed Agent)

As a positive electrode mixed agent, a powder (particle) of a lithium transition metal oxide shown in Table 1, which serves as the core part, a powder of a solid electrolyte shown in Table 1, and a powder of graphite as a conductive auxiliary agent were prepared and then were each weighed and mixed so that the ratio thereof was 50% by mass:40% by mass:10% by mass (lithium transition metal oxide:solid electrolyte:conductive auxiliary agent).

### (Production of Negative Electrode Mixed Agent)

As a negative electrode mixed agent, a powder of lithium titanate as a negative electrode active material, a powder of a solid electrolyte shown in Table 1, and a powder of graphite as a conductive auxiliary agent were prepared and then were each weighed and mixed so that the ratio thereof was 40% by mass:50% by mass:10% by mass (negative electrode active material:solid electrolyte:conductive auxiliary agent).

### (Production of Molded Body)

A resin holder having a through hole having a diameter of 12 mm in the center, and a lower punch and an upper punch, which were made of a SKD11 material and had a diameter of 11.99 mm, were prepared. The lower punch was inserted from under the through hole of the resin holder, and the positive electrode mixed agent, Li₂ZrSO₄Cl₄ (LZSOC) as a solid electrolyte, and the negative electrode mixed agent, which were powdery materials, were charged in this order from the opening side of the resin holder.

Next, the upper punch was inserted onto the charged powdery material, and a unit having an upper punch, a resin holder for accommodating a powdery material, and a lower punch was allowed to stand in a pressing machine and pressed at a pressure of 20 kPa to produce a molded body.

Next, a positive electrode current collector having a diameter of 12 mm and a thickness of 15 μm, which was made of an aluminum foil, was installed on the positive electrode active material. In addition, a negative electrode current collector having a diameter of 12 mm and a thickness of 9 μm, which was made of a copper foil, was installed under the negative electrode active material layer. Through the above-described procedure, the laminate 4 in which the lamination had been carried out in the order of the positive electrode current collectors 1A/the positive electrode active material layer 1B/the solid electrolyte layer 3/the negative electrode active material layer 2B/the negative electrode current collectors 2A was obtained.

Next, according to a publicly known method, an external terminal was welded to each of the positive electrode current collector 1A of the positive electrode layer 1 and the negative electrode current collector 2A of the negative electrode layer 2, which formed the laminate 4, and the positive electrode current collector 1A or the negative electrode current collector 2A was electrically connected to the external terminal. After that, the laminate 4 connected to the external terminal was stored in an exterior body made of an aluminum laminate material. Then, the opening portion of the exterior body was sealed by heat sealing to form an all-solid state secondary battery structure.

Next, the all-solid state secondary battery structure formed in this way was subjected to the initial charging and discharging according to the method shown below.

The all-solid state secondary battery structure was allowed to stand in a constant temperature bath at 60° C., and charging at a constant current was carried out at 0.05 C by using a charging and discharging machine SD8 (made by HOKUTO DENKO Corporation) until the battery voltage reached 2.80 V. Next, charging at a constant voltage at a battery voltage of 2.8 V was carried out for 6.0 hours. The conditions at the time of the initial charging are shown in Table 2. After that, discharging at a constant current was carried out at 0.05 C until the battery voltage reached 1.3 V.

Through the above processes, an all-solid state secondary battery 100 of Example 1 was obtained.

TABLE 1

| | | | | | | | Ratio between | |
|---|---|---|---|---|---|---|---|---|
| | | | | | | | contents of | |
| | | | | | | | halogen | |
| | | | | | | | elements at | |
| | | Core part | | | | | interfaces | |
| | | | Average | | | | (interface | |
| | | | particle | Shell part | | | with core | |
| | | Lithium | diameter | | Average | | part/ | |
| | | transition | of core | | thickness of | Proportion | interface | Self- |
| | Solid | metal | part | IIalogen | shell part | of area | with solid | discharge |
| | electrolyte | oxide | (μm) | element | (μm) | (%) | electrolyte) | (mV/day) |
| Example 1 | LZSOC | LCO | 15 | Cl | 0.5 | 20 | 0.9 | 0.28 |
| Example 2 | LZSOC | LCO | 15 | Cl | 0.5 | 20 | 0.6 | 0.26 |
| Example 3 | LZSOC | LCO | 15 | Cl | 0.5 | 20 | 0.5 | 0.65 |
| Example 4 | LZSOC | LCO | 15 | Cl | 0.5 | 20 | 1.0 | 0.63 |
| Example 5 | LZOC | LCO | 15 | Cl | 0.5 | 20 | 1.0 | 0.65 |
| Example 6 | LZBr | LCO | 15 | Br | 0.5 | 20 | 1.0 | 0.65 |
| Example 7 | LZBr | LCO | 15 | Cl | 0.5 | 20 | 1.0 | 0.93 |
| Example 8 | LZSOC | LCO | 15 | Br | 0.5 | 20 | 1.0 | 0.94 |
| Example 9 | LZSOC | LCO | 15 | Br | 0.5 | 0.8 | 1.0 | 1.24 |
| Example 10 | LZSOC | LCO | 15 | Br | 0.5 | 1 | 1.0 | 0.93 |
| Example 11 | LZSOC | LCO | 15 | Br | 0.5 | 20 | 1.0 | 0.91 |
| Example 12 | LZSOC | LCO | 15 | Br | 0.5 | 40 | 1.0 | 0.95 |
| Example 13 | LZSOC | LCO | 15 | Br | 0.5 | 41 | 1.0 | 1.24 |
| Example 14 | LZSOC | LCO | 15 | Br | 0.09 | 0.5 | 1.0 | 1.50 |
| Example 15 | LZSOC | LCO | 15 | Br | 0.1 | 0.5 | 1.0 | 1.29 |
| Example 16 | LZSOC | LCO | 15 | Br | 0.5 | 0.5 | 1.0 | 1.25 |
| Example 17 | LZSOC | LCO | 15 | Br | 1.0 | 0.5 | 1.0 | 1.26 |
| Example 18 | LZSOC | LCO | 15 | Br | 1.1 | 0.5 | 1.0 | 1.51 |
| Example 19 | LZSOC | LCO | 15 | Br | 0.05 | 0.5 | 1.0 | 1.50 |
| Example 20 | LZC | LCO | 15 | Br | 0.05 | 0.5 | 1.0 | 1.58 |
| Example 21 | LZSOC | NCM | 15 | Br | 0.05 | 0.5 | 1.0 | 1.52 |
| Example 22 | LZSOC | NCA | 15 | Br | 0.05 | 0.5 | 1.0 | 1.53 |
| Comparative | LZSOC | LCO | 15 | — | — | — | — | 2.70 |
| Example 1 | | | | | | | | |
| Comparative | LGPS | LCO | 15 | Cl | 0.5 | 20 | 0.9 | 2.80 |
| Example 2 | | | | | | | | |

TABLE 2

| | Conditions in initial charging | | | |
|---|---|---|---|---|
| | Battery | Time for | Condition for | |
| | voltage at | charging at | charging at | |
| | upper limit | constant | constant | Temperature |
| | (V) | voltage (hours) | current | (° C.) |
| Example 1 | 2.80 | 6.0 | 0.05 C | 60 |
| Example 2 | 2.84 | 6.0 | 0.05 C | 60 |
| Example 3 | 2.85 | 6.0 | 0.05 C | 60 |
| Example 4 | 2.79 | 6.0 | 0.05 C | 60 |
| Example 5 | 2.79 | 6.0 | 0.05 C | 60 |
| Example 6 | 2.79 | 6.0 | 0.05 C | 60 |
| Example 7 | 2.79 | 6.0 | 0.05 C | 60 |
| Example 8 | 2.79 | 6.0 | 0.05 C | 60 |
| Example 9 | 2.79 | 6.0 | 1.00 C | 60 |
| Example 10 | 2.79 | 6.0 | 0.80 C | 60 |
| Example 11 | 2.79 | 6.0 | 0.10 C | 60 |
| Example 12 | 2.79 | 6.0 | 0.02 C | 60 |
| Example 13 | 2.79 | 6.0 | 0.01 C | 60 |
| Example 14 | 2.79 | 0.5 | 0.05 C | 60 |
| Example 15 | 2.79 | 1.0 | 0.05 C | 60 |
| Example 16 | 2.79 | 4.0 | 0.05 C | 60 |
| Example 17 | 2.79 | 7.0 | 0.05 C | 60 |
| Example 18 | 2.79 | 8.0 | 0.05 C | 60 |
| Example 19 | 2.79 | 0.3 | 2.00 C | 60 |
| Example 20 | 2.79 | 6.0 | 0.05 C | 60 |
| Example 21 | 2.79 | 6.0 | 0.05 C | 60 |
| Example 22 | 2.79 | 6.0 | 0.05 C | 60 |
| Comparative | 2.80 | 6.0 | 0.05 C | 20 |
| Example 1 | | | | |
| Comparative | 2.79 | 6.0 | 0.05 C | 60 |
| Example 2 | | | | |

The lithium transition metal oxides shown in Table 1 are those shown below.
(LCO): LiCoO₂
(NCM): LiNi_{1/3}Mn_{1/3}Co_{1/3}O₂
(NCA): LiNi_{0.85}Co_{0.10}Al_{0.05}O₂

The solid electrolytes shown in Table 1 are those shown below.
(LZSOC): Li₂ZrSO₄Cl₄
(LZOC): Li₂ZrCCl₄
(LZC): Li₂ZrCl₆
(LZBr): Li₂ZrBr₆
(LGPS): Li₁₀GeP₂S₁₂

### Example 2 to Example 4

An all-solid state secondary battery 100 in each of Example 2 to Example 4 was obtained in the same manner as in Example 1, except that the battery voltage at the upper limit at the time of initial charging was set to 2.84 V in Example 2, 2.85 V in Example 3, and 2.79 V in Example 4, as shown in Table 2.

### Example 5 and Example 6

An all-solid state secondary battery 100 in each of Example 5 and Example 6 was obtained in the same manner as in Example 4, except that the positive electrode mixed agent was produced using the solid electrolyte shown in Table 1.

### Example 7

An all-solid state secondary battery 100 in Example 7 was obtained in the same manner as in Example 4, except that the positive electrode mixed agent was produced by a method in which a mixture was prepared by mixing a powder (particle) of a lithium transition metal oxide shown in Table 1, which serves as a core part, and sodium chloride, and the obtained mixture was mixed with a powder of the solid electrolyte shown in Table 1 and a powder of graphite as a conductive auxiliary agent. The proportion of each component in the positive electrode mixed agent was set to 50% by mass:40% by mass:10% by mass (lithium transition metal oxide:solid electrolyte:conductive auxiliary agent), and the proportion of sodium chloride was set to 2 parts by mass with respect to a total of 100 parts by mass of the lithium transition metal oxide, the solid electrolyte, and the conductive auxiliary agent.

### Example 8

An all-solid state secondary battery 100 in Example 8 was obtained in the same manner as in Example 4, except that the positive electrode mixed agent was produced by a method in which a mixture was prepared by mixing a powder (particle) of a lithium transition metal oxide shown in Table 1, which serves as a core part, and sodium bromide, and the obtained mixture was mixed with a powder of the solid electrolyte shown in Table 1 and a powder of graphite as a conductive auxiliary agent. The proportion of each component in the positive electrode mixed agent was set to 50% by mass:40% by mass:10% by mass (lithium transition metal oxide:solid electrolyte:conductive auxiliary agent), and the proportion of sodium bromide was set to 2 parts by mass with respect to a total of 100 parts by mass of the lithium transition metal oxide, the solid electrolyte, and the conductive auxiliary agent.

### Example 9 to Example 13

An all-solid state secondary battery 100 in each of Example 9 to Example 13 was obtained in the same manner as in Example 8, except that the condition for charging at a constant current at the time of initial charging was set to 1.00 C in Example 9, 0.80 C in Example 10, 0.10 C in Example 11, 0.02 C in Example 12, and 0.01 C in Example 13, as shown in Table 2.

### Example 14 to Example 18

An all-solid state secondary battery 100 in each of Example 14 to Example 18 was obtained in the same manner as in Example 8, except that the time for charging at a constant voltage at the time of initial charging was set to 0.5 hours in Example 14, 1.0 hours in Example 15, 4.0 hours in Example 16, 7.0 hours in Example 17, and 8.0 hours in Example 18, as shown in Table 2.

### Example 19

An all-solid state secondary battery 100 in Example 19 was obtained in the same manner as in Example 8, except that the condition for charging at a constant current at the time of initial charging was set to 2.00 C, and the time for charging at a constant voltage at the time of initial charging was set to 0.3 hours, as shown in Table 2.

### Example 20

An all-solid state secondary battery 100 in Example 20 was obtained in the same manner as in Example 8, except that the positive electrode mixed agent was produced using the solid electrolyte shown in Table 1.

### Example 21 and Example 22

An all-solid state secondary battery 100 in each of Example 21 and Example 22 was obtained in the same manner as in Example 8, except that the positive electrode mixed agent was produced using the lithium transition metal oxide shown in Table 1.

### Comparative Example 1

An all-solid state secondary battery 100 in Comparative Example 1 was obtained in the same manner as in Example 1, except that the temperature at the time of initial charging was set to 20° C. as shown in Table 1.

### Comparative Example 2

An all-solid state secondary battery 100 in Comparative Example 2 was obtained in the same manner as in Example 7, except that the positive electrode mixed agent was produced using the solid electrolyte shown in Table 1.

According to the methods shown below, the all-solid state secondary battery in each of Examples 1 to 22, Comparative Example 1, and Comparative Example 2 which were obtained in a manner as described above was subjected to measurements of “the average particle diameter of the core part”, “the halogen element” contained in the shell part of the particle having a core-shell structure, “the average thickness of the shell part”, “the proportion of the area” of the shell part to the cross sectional area of the particles having a core-shell structure, “the ratio of the content of halogen elements at the interface between the shell part and the core part to the content of halogen elements at the interface between the shell part and the solid electrolyte (the interface with the core part/the interface with the solid electrolyte)”, and “the self-discharge characteristics (self-discharge)”. The results are shown in Table 1.

### “Average Particle Diameter of Core Part”

A cut cross section of the positive electrode active material layer 1B was observed at a magnification of 30 k times using a scanning electron microscope (SEM) (trade name: SU3800; manufactured by Hitachi High-Tech Corporation). An image obtained was made into a black-and-white image of 8 bits (256 gradations) by using image analysis software (imageJ), thereby obtaining a gray scale image of 256 tones of the particles 10 having a core-shell structure. In the particle 10 having a core-shell structure in the obtained image, a light color region (whiteish region (average brightness of 193 to 207 in terms of gray scale)) was defined as the core part 10a, and a dark color region (blackish region (average brightness of 174 to 187 in terms of gray scale)) was defined as the shell part 10b. The diameter of the core part 10a was measured for all the particles 10 having all core-shell structures, which were included in a measurement range of a square of 100 μm long and 100 μm wide in the field of view, and the average value thereof was defined as the average particle diameter of the core part 10a.

### “Halogen Element Contained in Shell Part of Particle Having Core-Shell Structure”

Any particles 10 having a core-shell structure in the cut cross section of the positive electrode active material layer 1B were subjected to a mapping analysis of halogen elements (in a measurement range of a square of 3 μm long and 3 μm wide, measurement interval: 0.1 μm) by using a scanning transmission electron microscope (STEM) energy dispersive X-ray spectroscopy (EDS) apparatus (trade name: HD-2700; manufactured by Hitachi High-Tech Corporation). As a result, the halogen element in the shell part 10b of the particle 10 having a core-shell structure was identified.

### “Average Thickness of Shell Part”

A cut cross section of the positive electrode active material layer 1B was observed at a magnification of 30 k times using a scanning electron microscope (SEM) (trade name: SU3800; manufactured by Hitachi High-Tech Corporation). An image obtained was made into a black-and-white image of 8 bits (256 gradations) by using image analysis software (imageJ), thereby obtaining a gray scale image of 256 tones of the particles 10 having a core-shell structure. In the particle 10 having a core-shell structure in the obtained image, a light color region (whiteish region (average brightness of 193 to 207 in terms of gray scale)) was defined as the core part 10a, and a dark color region (blackish region (average brightness of 174 to 187 in terms of gray scale)) was defined as the shell part 10b. Regarding any one particle 10 having a core-shell structure in a field of view, the thickness of the shell part 10b along the diameter direction of the particles 10 was measured at any five locations, and the average value thereof was defined as the average thickness of the shell part 10b.

### “Proportion of Area of Shell Part to Cross Sectional Area of Particle Having Core-Shell Structure”

A gray scale image of 256 tones of the particles 10 having a core-shell structure was obtained in the same manner as in the case where the average thickness of the shell part 10b was measured. Regarding the particle 10 having a core-shell structure in the obtained image, a light color region was defined as the core part 10a, and a dark color region was defined as the shell part 10b in the same manner as in the case where the average thickness of the shell part 10b was measured. In addition, regarding each of any five particles 10 having a core-shell structure in the field of view, an area of the core part 10a and an area of the shell part 10b were determined. Using the obtained value, the proportion of the area of the shell part 10b to the cross sectional area of each of the particles 10 having a core-shell structure ({area of shell part 10b/(area of core part 10a+ area of shell part 10b)}×100(%)) was calculated for the five particle 10 having a core-shell structure, and the average value thereof was defined as the proportion of the area of the shell part 10b to the cross sectional area of the particle 10 having a core-shell structure.

“Ratio of Content of Halogen Elements at Interface Between Shell Part and Core Part to Content of Halogen Elements at Interface Between Shell Part and Solid Electrolyte (Interface with Core Part/Interface with Solid Electrolyte)”

Any five particles 10 having a core-shell structure in the cut cross section of the positive electrode active material layer 1B were subjected to a mapping analysis of halogen elements (in a measurement range of a square of 3 μm long and 3 μm wide, measurement interval: 0.1 μm) by using a scanning transmission electron microscope (STEM) energy dispersive X-ray spectroscopy (EDS) apparatus (trade name: HD-2700; manufactured by Hitachi High-Tech Corporation). Then, regarding each of any five particles 10 having a core-shell structure in the field of view, the ratio of the content of the halogen elements (interface between shell part 10b and core part 10a/interface between shell part 10b and solid electrolyte 11) was calculated using a measured value at a location closest to the interface with the core part 10a and a measured value at a location closest to the interface with the solid electrolyte 11 in the shell part 10b having the greatest thickness along the diameter direction of the particle 10, and the average value thereof was calculated.

### “Self-Discharge Characteristics (Self-Discharge)”

The all-solid state secondary battery was subjected to charging by charging at a constant current at a charging rate of 1.0 C (a current value at which charging is completed in 1 hour in a case where charging at a constant current is carried out at 25° C.) until the battery voltage reached 2.8 V, by using a secondary battery charging and discharging test device (manufactured by HOKUTO DENKO Corporation). After the charging was completed, a voltage after being allowed to stand at room temperature for 24 hours was denoted as V1, and then a voltage after being allowed to stand in an environment of 40° C. for 5 days was denoted as V2. Using the obtained values of V1 and V2, self-discharge was determined using Equation (I) below.

$$Self - discharge ( mV / day ) = V 1 - V 2 \qquad ( 1 )$$

As shown in Table 1, in the all-solid state secondary battery in each of Example 1 to Example 22, the self-discharge was suppressed as compared with the all-solid state secondary battery in each of Comparative Example 1 and Comparative Example 2.

In particular, in the all-solid state secondary battery in each of Example 1 and Example 2, in which the ratio between the contents of halogen elements at the interfaces was 0.6 or more and less than 1.0, the self-discharge was greatly suppressed as compared with Example 3 in which the ratio between the contents of halogen elements at the interfaces was 0.5, and Examples 4 to 22 in which the ratio between the contents of halogen elements at the interfaces was 1.0.

In Example 4 in which the halogen element contained in the shell part 10b was Cl, the self-discharge was greatly suppressed as compared with Example 8 in which the halogen element contained in the shell part 10b was Br.

In addition, in Example 6 in which the halogen element of the shell part 10b was the same as the halogen element contained in the solid electrolyte 11 of the positive electrode active material layer 1B, the self-discharge was greatly suppressed as compared with Example 7 in which the halogen element of the shell part 10b was different from the halogen element contained in the solid electrolyte 11 of the positive electrode active material layer 1B.

In Examples 10 to 12 in which the proportion of the area of the shell part 10b to the cross sectional area of the particles having a core-shell structure was 1% to 40%, the self-discharge was suppressed as compared with Examples 9 in which the proportion of the area of the shell part 10b was less than 1%, and Example 13 in which the proportion of the area of the shell part 10b was more than 40%.

In addition, in Examples 15 to 17 in which the thickness of the shell part 10b was 0.1 μm to 1.0 μm, the self-discharge was suppressed as compared with Example 14 in which the thickness of the shell part 10b was less than 0.1 μm, and Example 18 in which the thickness of the shell part 10b was more than 1.0 μm.

### INDUSTRIAL APPLICABILITY

According to the present invention, it is possible to provide a positive electrode active material layer that is capable of forming a positive electrode of an all-solid state secondary battery in which self-discharge is suppressed, and a positive electrode and an all-solid state secondary battery which include the positive electrode active material layer.

### REFERENCE SIGNS LIST

1 Positive electrode layer
1A Positive electrode current collector
1B Positive electrode active material layer
2 Negative electrode layer
2A Negative electrode current collector
2B Negative electrode active material layer
3 Solid electrolyte layer
4 Laminate
10 Particle having core-shell structure
10a Core part
10b Shell part
11 Solid electrolyte
12 Conductive auxiliary agent
100 All-solid state secondary battery

1. A positive electrode active material layer comprising:
a positive electrode active material; and
a solid electrolyte,
wherein the positive electrode active material contains a particle having a core-shell structure that has a core part and a shell part covering at least a part of a surface of the core part,
the core part consisting of a lithium transition metal oxide represented by Formula (1),
the shell part consisting of a compound containing oxygen and at least one halogen element selected from the group consisting of F, Cl, Br, and I, and
the solid electrolyte includes a halide-based solid electrolyte represented by Formula (2), 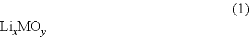
(in Formula (1), M is one or more kinds of transition metals,
0.1<x<1.1, 1.8<y<2.2) 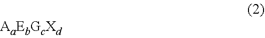
(in Formula (2), A is at least one element selected from Li and Cs,
E is at least one element selected from the group consisting of Al, Sc, Y, Zr, Hf, and lanthanoids,
G is at least group selected from the group consisting of OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, O, SO, SO₂, SO₃, SO₄, SO₅, S₂O₃, S₂O₄, S₂O₅, S₂O₆, S₂O₇, S₂O₈, BF₄, PF₆, and BOB, and
X is at least one element selected from the group consisting of F, Cl, Br, and I,
0.5≤a<6, 0<b<2, 0≤c≤6, 0<d≤6.1).

2. The positive electrode active material layer according to claim 1, wherein an average thickness of the shell part is 0.1 μm to 1.0 μm.

3. The positive electrode active material layer according to claim 1, wherein a proportion of an area of the shell part to a cross sectional area of the particles having the core-shell structure is 1% to 40%.

4. The positive electrode active material layer according to claim 1, wherein the halogen element contained in the shell part and a halogen element contained in the solid electrolyte are the same elements.

5. The positive electrode active material layer according to claim 1, wherein a ratio of a content of halogen elements at an interface between the shell part and the core part to a content of halogen elements at an interface between the shell part and the solid electrolyte is 0.6 or more and less than 1.0.

6. A positive electrode comprising:
the positive electrode active material layer according to claim 1.

7. An all-solid state secondary battery comprising:
the positive electrode according to claim 6;
a negative electrode; and
a solid electrolyte layer.

8. The all-solid state secondary battery according to claim 7,
wherein the solid electrolyte layer contains a halide-based solid electrolyte represented by Formula (2), 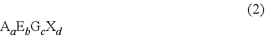
(in Formula (2), A is at least one element selected from Li and Cs,
E is at least one element selected from the group consisting of Al, Sc, Y, Zr, Hf, and lanthanoids,
G is at least group selected from the group consisting of OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, O, SO, SO₂, SO₃, SO₄, SO₅, S₂O₃, S₂O₄, S₂O₅, S₂O₆, S₂O₇, S₂O₈, BF₄, PF₆, and BOB, and
X is at least one element selected from the group consisting of F, Cl, Br, and I,
0.5≤a<6, 0<b<2, 0≤c≤6, 0<d≤6.1).

9. The all-solid state secondary battery according to claim 8,
wherein the solid electrolyte layer contains Li₂ZrSO₄Cl₄.

10. A positive electrode comprising:
the positive electrode active material layer according to claim 2.

11. A positive electrode comprising:
the positive electrode active material layer according to claim 3.

12. A positive electrode comprising:
the positive electrode active material layer according to claim 4.

13. A positive electrode comprising:
the positive electrode active material layer according to claim 5.
